(19) United States
(12) Patent Application Publication
(10) Pub. No.: US 2017/0257721 A1
(43) Pub. Date: Sep. 7, 2017

(54) AUDIO PROCESSING DEVICE AND METHOD

(71) Applicant: SONY SEMICONDUCTOR SOLUTIONS CORPORATION, Kanagawa (JP)

(72) Inventors: RIE KASUGA, KANAGAWA (JP); HIROYUKI FUKUCHI, KANAGAWA (JP); RYUJI TOKUNAGA, TOKYO (JP); MASAKI YOSHIMURA, KANAGAWA (JP)

(21) Appl. No.: 15/508,806

(22) PCT Filed: Aug. 28, 2015
(86) PCT No.: PCT/JP2015/074340

§ 371 Date: Mar. 3, 2017

(30) Foreign Application Priority Data
Sep. 12, 2014 (JP) 2014-185969

(51) Int. Cl. H04S 3/02; G10L 21/055

(52) U.S. Cl. CPC H04S 3/02; G10L 21/055; H04S 2400/03; H04S 2400/11

(57) ABSTRACT

The present disclosure relates to an audio processing device and a method therefor allowing a localization position of a sound image to be readily changed. A coefficient computation unit 23 adds or subtracts coefficients k_Ls, k_L, k_C, k_R, and k_Rs set for respective channels by a control unit 21 to or from audio signals Ls, L, C, R, and Rs from a delay unit 22, respectively. A dividing unit divides an audio signal C form the coefficient computation unit into two channel outputs, outputs a signal obtained by multiplying an audio signal C resulting from the division by delay_α to a combining unit of a channel L, and outputs a signal obtained by multiplying an audio signal C resulting from the division by delay_β to a combining unit of a channel R. The present disclosure is applicable to a downmixer that downmixes audio signals from two or more channels to two channels.

### TECHNICAL FIELD

The present disclosure relates to an audio processing device and a method therefor, and more particularly to an audio processing device and a method therefor allowing a localization position of a sound image to be readily changed.

### BACKGROUND ART

In digital broadcasting in Japan, algorithms for downmixing 5.1 ch surround to stereo 2 ch to be conducted by receivers are specified (refer to Non-patent Documents 1 to 3).

### CITATION LIST

### Non-Patent Document

Non-patent Document 1: “Multichannel stereophonic sound system with and without accompanying picture,” ITU-R Recommendation BS.775, 2012, 08
Non-patent Document 2: “Receiver for Digital Broadcasting (Desirable Specifications),” ARIB STD-B21, Oct. 26, 1999
Non-patent Document 3: “Video Coding, Audio Coding and Multiplexing Specifications for Digital Broadcasting,” ARIB STD-B32, May 31, 2001

### SUMMARY OF THE INVENTION

### Problems to be Solved by the Invention

According to the aforementioned standards, however, the localization position of a sound image after downmixing is difficult to change.

The present disclosure is achieved in view of the aforementioned circumstances, and allows a localization position of a sound image to be readily changed.

### Solutions to Problems

An audio processing device according to a first aspect of the present disclosure includes: a delay unit configured to apply a delay to input audio signals of two or more channels depending on each of the channels; a setting unit configured to set a value of the delay; and a combining unit configured to combine the audio signals delayed by the delay unit, and output audio signals of output channels.

In an audio processing method according to the first aspect of the present disclosure, an audio processing device: applies a delay to input audio signals of two or more channels depending on each of the channels; sets a value of the delay; and combines the delayed audio signals, and outputs audio signals of output channels.

An audio processing device according to a second aspect of the present disclosure includes: a delay unit configured to apply a delay to input audio signals of two or more channels depending on each of the channels; an adjustment unit configured to adjust an increase or decrease in amplitude of the audio signals delayed by the delay unit; a setting unit configured to set a value of the delay and a coefficient value indicating the increase or decrease; and a combining unit configured to combine the audio signals subjected to adjustment of the increase or decrease in amplitude by the adjustment unit, and output audio signals of output channels.

The setting unit can set the value of the delay and the coefficient value in conjunction with each other.

For localizing a sound image frontward relative to a listening position, the setting unit can set the coefficient value so that sound becomes louder, and for localizing a sound image backward, the setting unit can set the coefficient value so that sound becomes less loud.

A correction unit configured to correct the audio signals subjected to adjustment of the increase or decrease in amplitude by the adjustment unit can further be included.

The correction unit can control a level of the audio signals subjected to adjustment of the increase or decrease in amplitude by the adjustment unit.

The correction unit can mute the audio signal subjected to adjustment of the increase or decrease in amplitude by the adjustment unit.

In an audio processing method according to the second aspect of the present disclosure, an audio processing device: applies a delay to input audio signals of two or more channels depending on each of the channels; adjusts an increase or decrease in amplitude of the delayed audio signals; sets a value of the delay and a coefficient value indicating the increase or decrease; and combines the audio signals subjected to adjustment of the increase or decrease in amplitude, and outputs audio signals of output channels.

An audio processing device according to a third aspect of the present disclosure includes: a dividing unit configured to apply a delay to at least an audio signal of one channel among input audio signals of two or more channels, and divide the delayed audio signal into two or more output channels; a combining unit configured to combine an input audio signal with the audio signal obtained by the division by the dividing unit, and output an audio signal of the output channels; and a setting unit configured to set a value of the delay depending on each of the output channels.

The setting unit can set the value of the delay so as to produce a Haas effect.

In an audio processing method according to the third aspect of the present disclosure, an audio processing device: applies a delay to at least an audio signal of one channel among input audio signals of two or more channels, and divide the delayed audio signal into two or more output channels; combines an input audio signal with the audio signal obtained by the division by the dividing unit, and outputs an audio signal of the output channels; and sets a value of the delay depending on each of the output channels.

In the first aspect of the present disclosure, a delay is applied to the input audio signals of two or more channels, and a value of the delay is set. In addition, the delayed audio signals are combined, and audio signals of output channels are output.

In the second aspect of the present disclosure, a delay is applied to the input audio signals of two or more channels, and an increase or decrease in amplitude of the delayed audio signals is adjusted. In addition, a value of the delay and a coefficient value indicating the increase or decrease are set, the audio signals subjected to the adjustment of the increase or decrease in amplitude are combined, and audio signals of output channels are output.

In the third aspect of the present disclosure, a delay is applied to at least an audio signal of one channel among input audio signals of two or more channels, the delayed audio signal is divided into two or more output channels, an input audio signal is combined with the audio signal obtained by the division, and audio signals of the output channels are output. In addition a value of the delay is set depending on each of the output channels.

### Effects of the Invention

According to the present disclosure, a localization position of a sound image can be changed. In particular, a localization position of a sound image can be readily changed.

Note that the effects mentioned herein are exemplary only, and effects of the present technology are not limited to those mentioned herein but may include additional effects.

### BRIEF DESCRIPTION OF DRAWINGS

FIG. 1 is a block diagram illustrating an example configuration of a downmixer to which the present technology is applied.

FIG. 2 is a diagram explaining the Haas effect.

FIG. 3 is a diagram explaining installation positions of speakers of a television set and a viewing distance.

FIG. 4 is a table illustrating examples of installation positions of speakers of a television set and a viewing distance.

FIG. 5 is a diagram explaining installation positions of speakers of a television set and a viewing distance.

FIG. 6 is a table illustrating examples of installation positions of speakers of a television set and a viewing distance.

FIG. 7 is a graph illustrating audio waveforms in a case of no delay.

FIG. 8 is a graph illustrating audio waveforms in a case where a delay is present.

FIG. 9 is a flowchart explaining audio signal processing.

FIG. 10 is a diagram illustrating frontward or backward localization.

FIG. 11 is a diagram illustrating frontward or backward localization.

FIG. 12 is a diagram illustrating frontward or backward localization.

FIG. 13 is a diagram illustrating frontward or backward localization.

FIG. 14 is a diagram illustrating frontward or backward localization.

FIG. 15 is a diagram illustrating leftward or rightward localization.

FIG. 16 is a diagram illustrating leftward or rightward localization.

FIG. 17 is a diagram illustrating leftward or rightward localization.

FIG. 18 is a diagram illustrating another example of leftward or rightward localization.

FIG. 19 is a block diagram illustrating another example configuration of a downmixer to which the present technology is applied.

FIG. 20 is a flowchart explaining audio signal processing.

FIG. 21 is a block diagram illustrating an example configuration of a computer.

### MODE FOR CARRYING OUT THE INVENTION

Modes for carrying out the present disclosure (hereinafter referred to as the embodiments) will be described below. Note that the description will be made in the following order.

1. First Embodiment (configuration of downmixer)

2. Second Embodiment (frontward or backward localization)

3. Third Embodiment (leftward or rightward localization)

4. Fourth Embodiment (another configuration of downmixer)

5. Fifth Embodiment (computer)

### First Embodiment

<Example Configuration of Device>

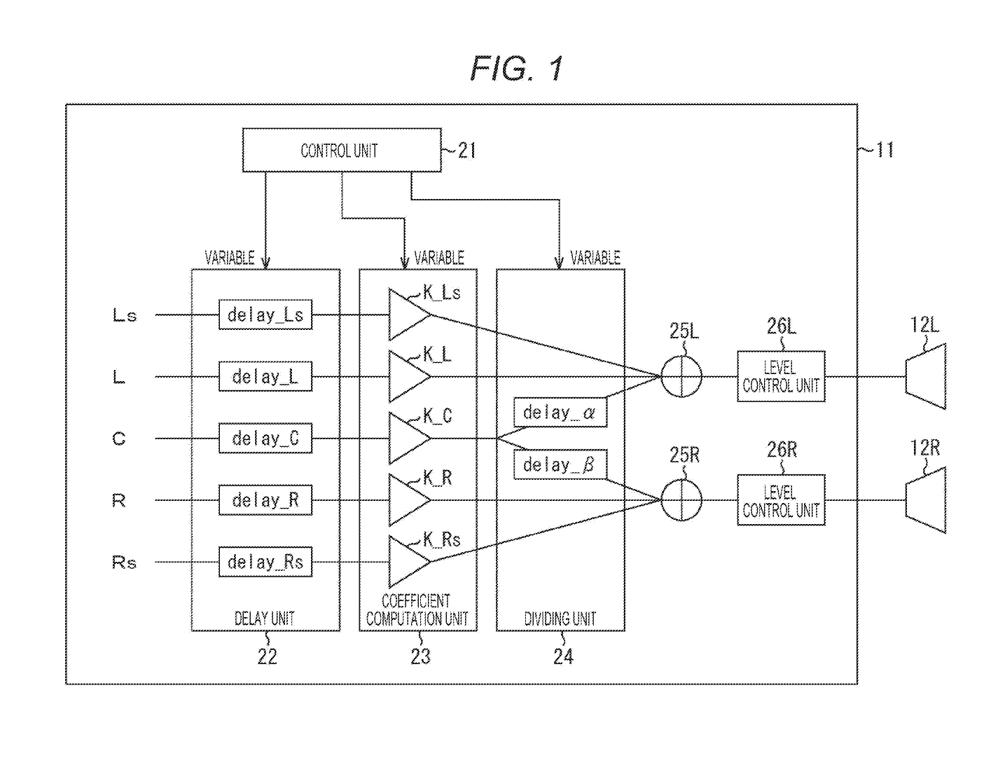

FIG. 1 is a block diagram illustrating an example configuration of a downmixer, which is an audio processing device to which the present technology is applied.

In the example of FIG. 1, a downmixer 11 is characterized in including a delay circuit, which can be set for each channel. The example of FIG. 1 shows an example configuration for downmixing five channels to two channels.

Specifically, the downmixer 11 receives input of five audio signals Ls, L, C, R, and Rs, and includes two speakers 12L and 12R. Note that Ls, L, C, R, and Rs respectively represent left surround, left, center, right, and right surround.

The downmixer 11 is configured to include a control unit 21, a delay unit 22, a coefficient computation unit 23, a dividing unit 24, combining units 25L and 25R, and level control units 26L and 26R.

The control unit 21 sets delay values and coefficient values for the delay unit 22, the coefficient computation unit 23, and the dividing unit 24 depending on each channel or leftward or rightward localization. The control unit 21 can also change a delay value and a coefficient value in conjunction with each other.

The delay unit 22 is a delay circuit that multiplies input audio signals Ls, L, C, R, and Rs respectively by delay_Ls, delay_L, delay_C, delay_R, and delay_Rs set for respective channels by the control unit 21. As a result, a position of a virtual speaker (a position of a sound image) is localized frontward or backward. Note that delay_Ls, delay_L, delay_C, delay_R, and delay_Rs are delay values.

The delay unit 22 outputs delayed signals for the respective channels to the coefficient computation unit 23. Note that, since a signal that needs no delay need not be delayed, such a signal is passed to the coefficient computation unit 23 without being delayed.

The coefficient computation unit 23 adds or subtracts k_Ls, k_L, k_C, k_R, and k_Rs set for the respective channels by the control unit 21 to or from the audio signals Ls, L, C, R, and Rs from the delay unit 22, respectively. The coefficient computation unit 23 outputs respective signals resulting from computation with the coefficients for the respective channels to the dividing unit 24. Note that k_Ls, k_L, k_C, k_R, and k_Rs are coefficient values.

The dividing unit 24 outputs the audio signal Ls and the audio signal L from the coefficient computation unit 23 to the combining unit 25L without any change. The dividing unit 24 outputs the audio signal Rs and the audio signal R from the coefficient computation unit 23 to the combining unit 25R without any change.

Furthermore, the dividing unit 24 divides the audio signal C from the coefficient computation unit 23 into two channel outputs, outputs a signal obtained by multiplying an audio signal C resulting from the division by delay_α to the combining unit 25L, and outputs a signal obtained by multiplying an audio signal C resulting from the division by delay_β to the combining unit 25R.

Note that delay_α and delay_β are delay values, which may be equal to each other, but delay_α and delay_β set to different values can produce the Haas effect described below, and allow positions of virtual speakers to be localized in left and right. Note that, in this example, a channel C is localized in left and right.

The combining unit 25L combines the audio signal Ls, the audio signal L, and the signal obtained by multiplying the audio signal C by delay_α, which are from the dividing unit 24, and outputs the combined result to the level control unit 26L. The combining unit 25R combines the audio signal Rs, the audio signal R, and the signal obtained by multiplying the audio signal C by delay_β, which are from the dividing unit 24, and outputs the combined result to the level control unit 26R.

The level control unit 26L corrects the audio signal from the combining unit 25L. Specifically, the level control unit 26L controls the level of the audio signal from the combining unit 25L for correction of the audio signal, and outputs the audio signal resulting from the level control to the speaker 12L. The level control unit 26R corrects the audio signal from the combining unit 25R. Specifically, the level control unit 26R controls the level of the audio signal for correction of the audio signal, and outputs the audio signal resulting from the level control to the speaker 12R. Note that, as one example of the level control, the level control disclosed in Japanese Patent Application Laid-Open No. 2010-003335 is used.

The speaker 12L outputs audio corresponding to the audio signal from the level control unit 26L. The speaker 12R outputs audio corresponding to the audio signal from the level control unit 26R.

As described above, the delay circuit is used for a process of combining audio signals to reduce the number of audio signals, which allows the position of a virtual speaker to be localized at a desired position in front, back, left, or right.

In addition, the delay values and the coefficient values may be fixed or may be changed continuously in time. Furthermore, a delay value and a coefficient value are changed in conjunction with each other by the control unit 21, which allows the position of a virtual speaker to be auditorily localized at a desired position.

<Outline of Haas Effect>

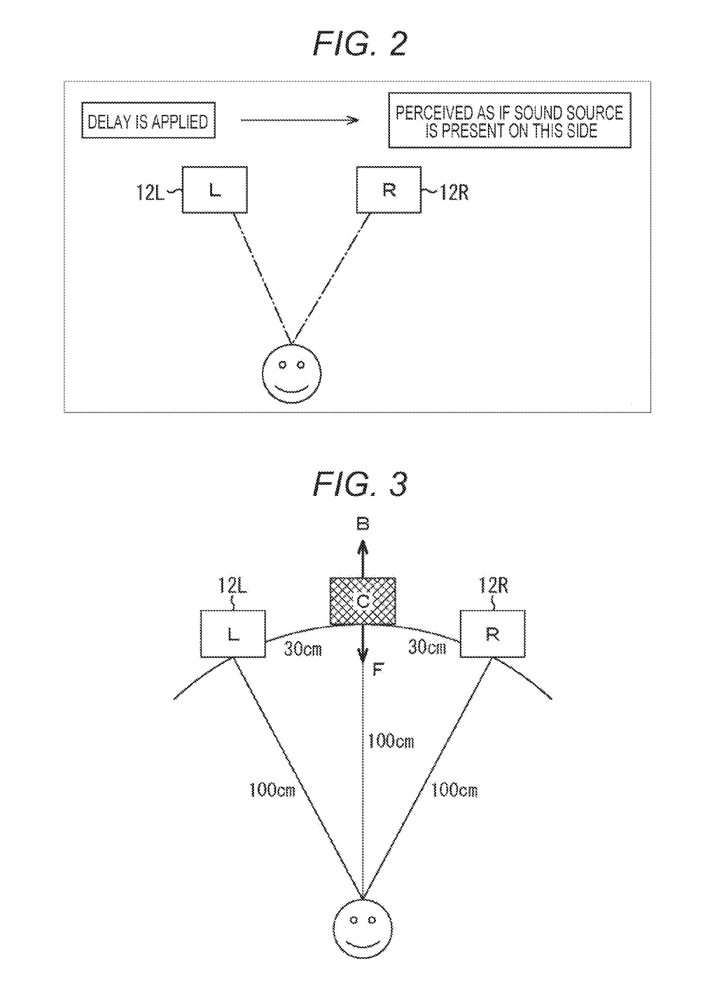

Next, the Haas effect will be described with reference to FIG. 2. In an example of FIG. 2, the positions where the speaker 12L and the speaker 12R are presented indicate speaker positions where the speaker 12L and the speaker 12R are disposed.

Assume that a user at a position at equal distance from the speaker 12L provided on the left and the speaker 12R provided on the right listens to the same audio from the both speakers 12L and 12R. In this case, if a delay is applied to the audio signal from the speaker 12L, the audio signal is perceived as coming from the direction of the speaker 12R, for example. That is, it sounds as if the sound source is on the speaker 12R side.

Such an effect is called the Haas effect, and a delay can be used for localization of the left and right positions.

<Relation Between Distance, Amplitude, and Delay>

Next, changes in the loudness of sound will be explained. Sound is perceived less loud as the distance of a sound image from the user's listening position (hereinafter referred to as a listening position) is longer, and sound is perceived louder as a sound image is closer. In other words, the amplitude of a perceived audio signal is smaller as a sound image is farther, and the amplitude of an audio signal is larger as a sound image is closer.

FIG. 3 illustrates approximate installation positions of speakers of a television set and a viewing distance. In the example of FIG. 3, the positions where the speaker 12L and the speaker 12R are presented indicate speaker positions where the speaker 12L and the speaker 12R are disposed, and the position represented by C indicates a sound image position (a virtual speaker position) of the channel C. In addition, if a sound image C of the channel C is assumed to be in the middle, the left speaker 12L is installed at a position of 30 cm to the left of the sound image C of the channel C. The right speaker 12R is installed at a position of 30 cm to the right of the sound image C of the channel C.

In addition, the user's listening position indicated by a face illustration is 100 cm to the front of the sound image C of the channel C, and also 100 cm away from the left speaker 12L and the right speaker 12R. In other words, the channel C, the left speaker 12L, and the right speaker 12R are arranged concentrically. Note that, unless otherwise stated, the speakers and the virtual speaker are also assumed to be arranged concentrically in the following description.

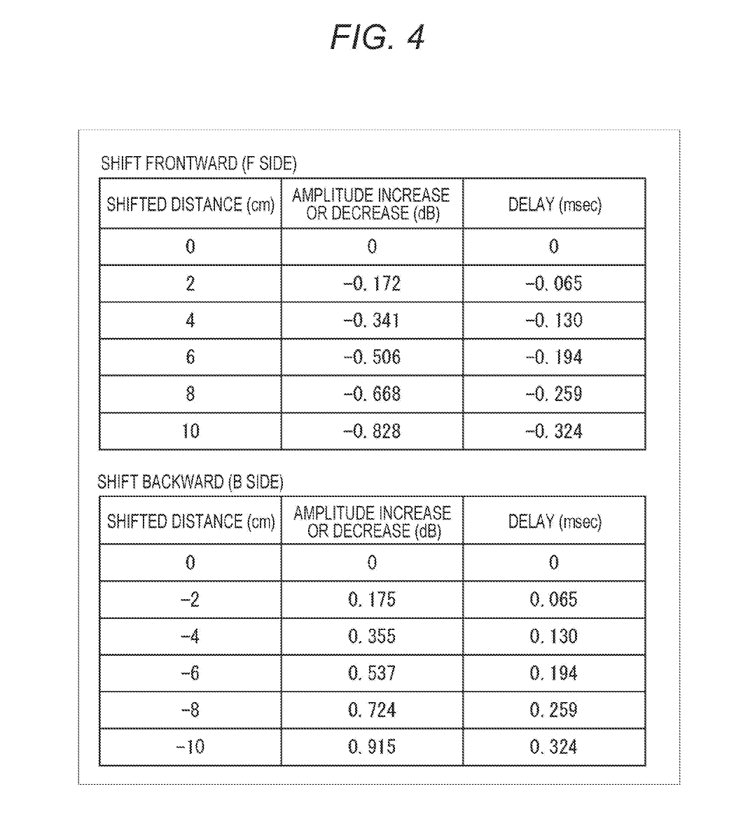

The examples in FIG. 4 indicate how much the increase or decrease in the amplitude and the delay change when the sound image C of the channel C is shifted frontward (on the arrow F side in FIG. 3) or backward (on the arrow B side in FIG. 3) in the case of the speaker installation positions and the viewing distance in the example of FIG. 3, which are obtained by calculation.

Specifically, in the arrangement of FIG. 3, when the sound image C of the channel C is shifted frontward (on the arrow F side) by 2 cm, the increase or decrease in the amplitude is −0.172 dB, and the delay is −0.065 msec. When the sound image C is shifted frontward by 4 cm, the increase or decrease in the amplitude is −0.341 dB and the delay is −0.130 msec. When the sound image C is shifted frontward by 6 cm, the increase or decrease in the amplitude is −0.506 dB and the delay is −0.194 msec. When the sound image C is shifted frontward by 8 cm, the increase or decrease in the amplitude is −0.668 dB and the delay is −0.259 msec. When the sound image C is shifted frontward by 10 cm, the increase or decrease in the amplitude is −0.828 dB and the delay is −0.324 msec.

In addition, in the arrangement of FIG. 3, when the sound image C of the channel C is shifted backward (on the arrow B side) by 2 cm, the increase or decrease in the amplitude is −0.175 dB and the delay is 0.065 msec. When the sound image C is shifted backward by 4 cm, the increase or decrease in the amplitude is 0.355 dB and the delay is 0.130 msec. When the sound image C is shifted backward by 6 cm, the increase or decrease in the amplitude is 0.537 dB and the delay is 0.194 msec. When the sound image C is shifted backward by 8 cm, the increase or decrease in the amplitude is 0.724 dB and the delay is 0.259 msec. When the sound image C is shifted backward by 10 cm, the increase or decrease in the amplitude is 0.915 dB and the delay is 0.324 msec.

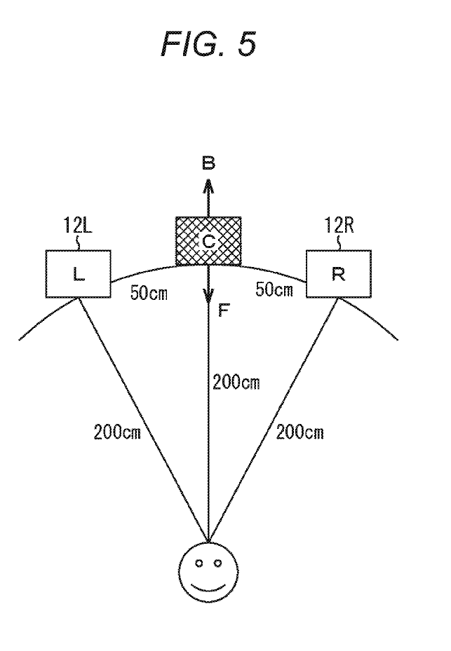

FIG. 5 illustrate another example of approximate installation positions of speakers of a television set and a viewing distance. In the example of FIG. 5, if a sound image C of the channel C is assumed to be in the middle, the left speaker 12L is installed at a position of 50 cm to the left of the sound image C of the channel C. The right speaker 12R is installed at a position of 50 cm to the right of the sound image C of the channel C.

In addition, the user's listening position is 200 cm to the front of the sound image C of the channel C, and also 200 cm away from the left speaker 12L and the right speaker 12R. In other words, similarly to the case of the example of FIG. 3, the channel C, the left speaker 12L, and the right speaker 12R are arranged concentrically. Note that, unless otherwise stated, the speakers and the virtual speaker are also assumed to be arranged concentrically in the following description.

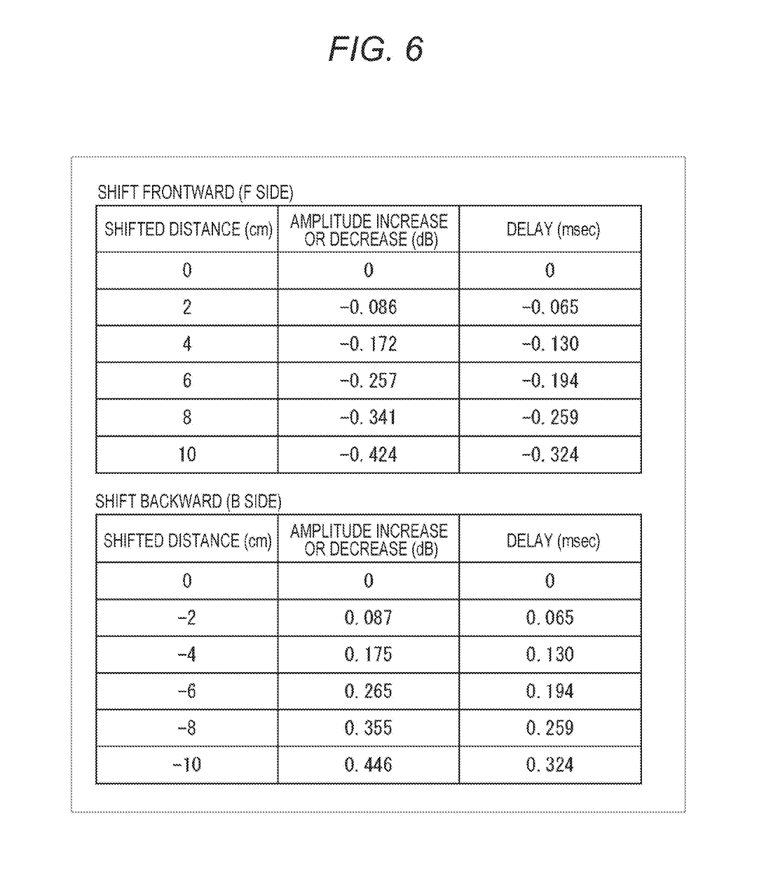

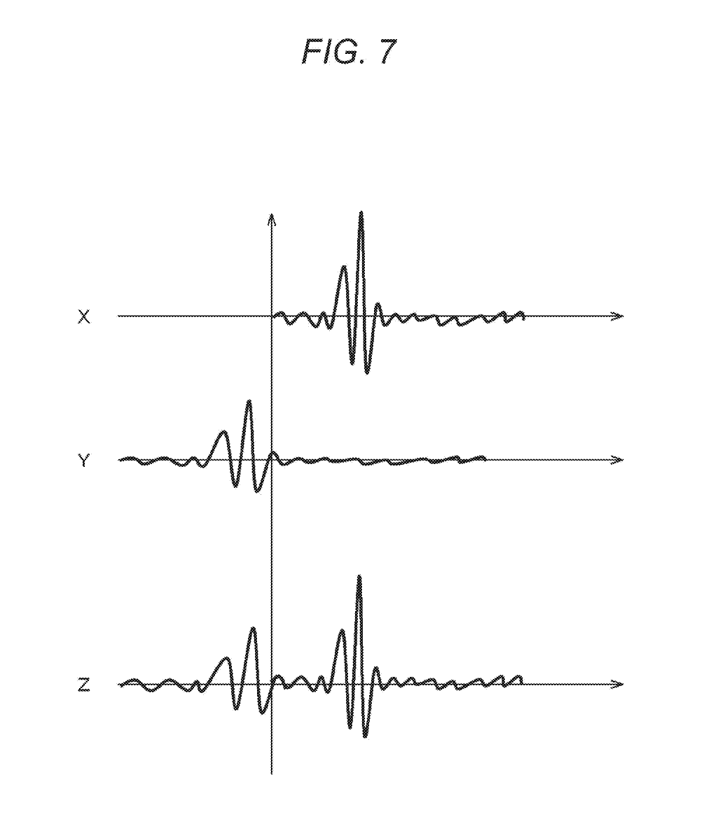

Examples in FIG. 6 indicate how much the increase or decrease in the amplitude and the delay change when the sound image C of the channel C is shifted frontward (on the arrow F side) or backward (on the arrow B side) in the case of the speaker installation positions and the viewing distance in the example of FIG. 5, which are obtained by calculation.

Specifically, in the arrangement of FIG. 5, when the sound image C of the channel C is shifted frontward (on the arrow F side) by 2 cm, the increase or decrease in the amplitude is −0.0086 dB, and the delay is −0.065 msec. When the sound image C is shifted frontward by 4 cm, the increase or decrease in the amplitude is −0.172 dB and the delay is −0.130 msec. When the sound image C is shifted frontward by 6 cm, the increase or decrease in the amplitude is −0.257 dB and the delay is −0.194 msec. When the sound image C is shifted frontward by 8 cm, the increase or decrease in the amplitude is −0.341 dB and the delay is −0.259 msec. When the sound image C is shifted frontward by 10 cm, the increase or decrease in the amplitude is −0.424 dB and the delay is −0.324 msec.

In addition, in the arrangement of FIG. 5, when the sound image C of the channel C is shifted backward (on the arrow B side) by 2 cm, the increase or decrease in the amplitude is −0.087 dB and the delay is 0.065 msec. When the sound image C is shifted backward by 4 cm, the increase or decrease in the amplitude is 0.175 dB and the delay is 0.130 msec. When the sound image C is shifted backward by 6 cm, the increase or decrease in the amplitude is 0.265 dB and the delay is 0.194 msec. When the sound image C is shifted backward by 8 cm, the increase or decrease in the amplitude is 0.355 dB and the delay is 0.259 msec. When the sound image C is shifted backward by 10 cm, the increase or decrease in the amplitude is 0.446 dB and the delay is 0.324 msec.

As described above, the amplitude of a perceived audio signal is smaller as a sound image is farther, and the amplitude of an audio signal is larger as a sound image is closer. Thus, it can be seen that changing a delay and a coefficient of amplitude in conjunction with each other in this manner allows the position of a virtual speaker to be auditorily localized.

<Level Control>

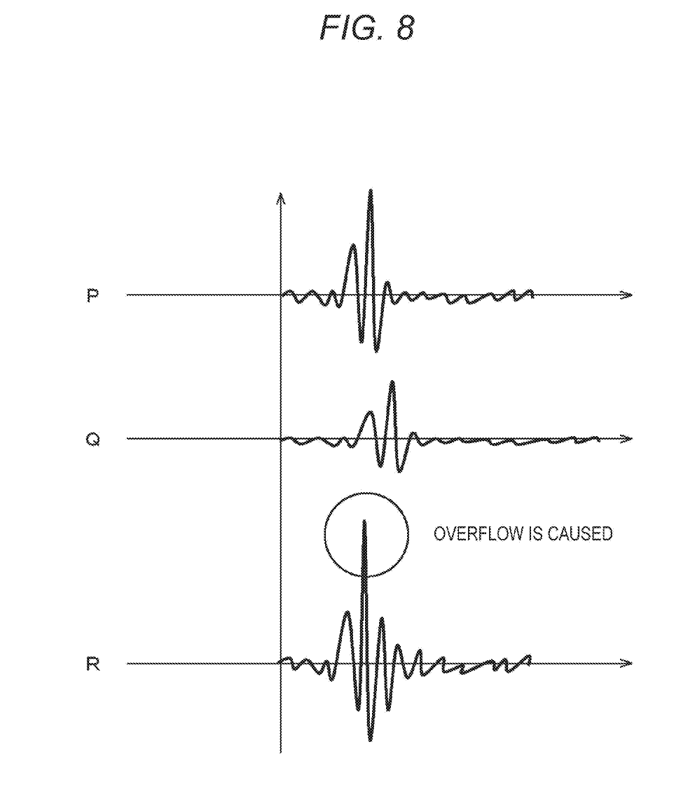

Next, the level control will be explained with reference to FIGS. 7 and 8.

FIG. 7 is a graph illustrating examples of audio waveforms before and after downmixing in a case of no delay. In the examples of FIG. 7, X and Y represent audio waveforms of respective channels, and Z represents an audio waveform obtained by downmixing the audio signals having the waveforms X and Y.

FIG. 8 is a graph illustrating examples of audio waveforms before and after downmixing in a case where a delay is present. Specifically, in the examples of FIG. 8, P and Q represent audio waveforms of respective channels, where a delay is applied in Q. In addition, R is an audio waveform obtained by downmixing the audio signals having the waveforms P and Q.

In the case of no delay in FIG. 7, downmixing is conducted without any problem. In contrast, in the case where a delay is present in FIG. 8, since the temporal position of downmixing is shifted as a result of using the delay, the loudness of the sound resulting from downmixing (the combining units 25L and 25R) may be unexpected by a sound source maker. In this case, the amplitude of part of R becomes too large, which causes an overflow to the sound resulting from downmixing.

The level control units 26L and 26R thus performs level control of signals to prevent overflows.

<Audio Signal Processing>

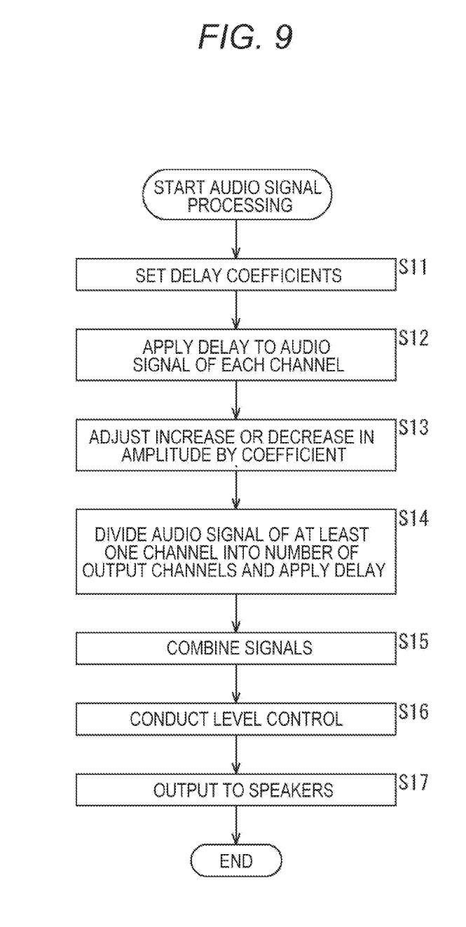

Next, downmixing performed by the downmixer 11 of FIG. 1 will be explained with reference to a flowchart of FIG. 9. Note that downmixing is one example of audio signal processing.

In step S11, the control unit 21 sets delays “delay” and coefficients k for the coefficient computation unit 23 and the dividing unit 24 depending on each channel or leftward or rightward localization.

Audio signals Ls, L, C, R, and Rs are input to the delay unit 22. In step S12, the delay unit 22 applies delays to the input audio signals depending on each channel, to localize a virtual speaker position frontward or backward.

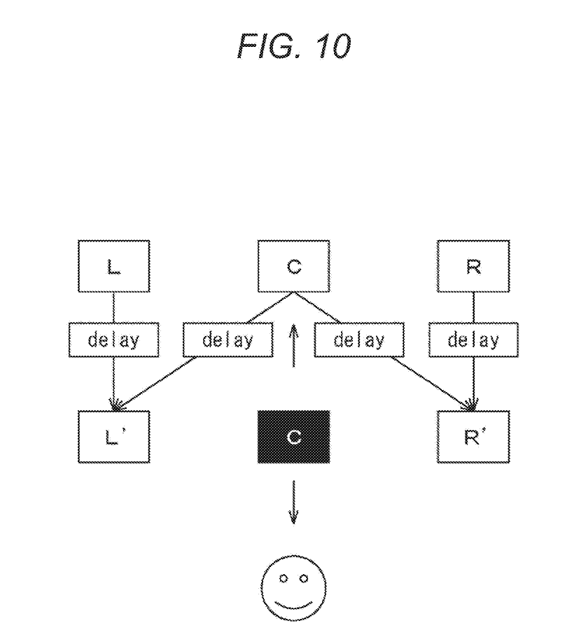

Specifically, the delay unit 22 multiplies the input audio signals Ls, L, C, R, and Rs respectively by delay_Ls, delay_L1, delay_C, delay_R, and delay_Rs set for the respective channels by the control unit 21. As a result, a position of a virtual speaker (a position of a sound image) is localized frontward or backward. Note that details of frontward or backward localization will be described later with reference to FIG. 10 and subsequent drawings.

The delay unit 22 outputs delayed signals for the respective channels to the coefficient computation unit 23. In step S13, the coefficient computation unit 23 adjusts an increase or decrease of the amplitude by a coefficient.

Specifically, the coefficient computation unit 23 adds or subtracts k_Ls, k_L, k_C, k_R, and k_Rs set for the respective channels by the control unit 21 to or from the audio signals Ls, L, C, R, and Rs from the delay unit 22, respectively. The coefficient computation unit 23 outputs respective signals resulting from computation with the coefficients for the respective channels to the dividing unit 24.

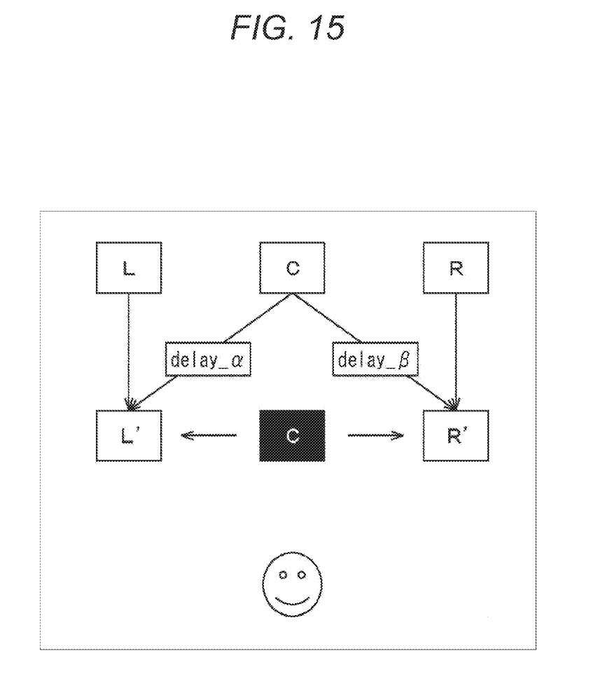

In step S14, the dividing unit 24 divides at least one of the input predetermined audio signals into the number of output channels, and applies delays depending on each output channel to the audio signals resulting from the division, to localize a virtual speaker position in left or right. Note that details of leftward or rightward localization will be described later with reference to FIG. 15 and subsequent drawings.

Specifically, the dividing unit 24 outputs the audio signal Ls and the audio signal L from the coefficient computation unit 23 to the combining unit 25L without any change. The dividing unit 24 outputs the audio signal Rs and the audio signal R from the coefficient computation unit 23 to the combining unit 25R without any change.

Furthermore, the dividing unit 24 divides the audio signal C from the coefficient computation unit 23 into two channel outputs, outputs a signal obtained by multiplying an audio signal C resulting from the division by delay_α to the combining unit 25L, and outputs a signal obtained by multiplying an audio signal C resulting from the division by delay_β to the combining unit 25R.

In step S15, the combining unit 25L and the combining unit 25R combines the audio signals. The combining unit 25L combines the audio signal Ls, the audio signal L, and the signal obtained by multiplying the audio signal C by delay_α, which are from the dividing unit 24, and outputs the combined result to the level control unit 26L. The combining unit 25R combines the audio signal Rs, the audio signal R, and the signal obtained by multiplying the audio signal C by delay_R, which are from the dividing unit 24, and outputs the combined result to the level control unit 26R.

In step S16, the level control unit 26L and the level control unit 26R controls the levels of the respective audio signals from the combining unit 25L and the combining unit 25R, and output the audio signals resulting from the level control to the speaker 12L.

In step 17, the speakers 12L and 12R outputs audio corresponding to the audio signals from the level control unit 26L and the level control unit 26R, respectively.

As described above, the delay circuit is used for downmixing, that is, a process of combining audio signals to reduce the number of audio signals, which allows the position of a virtual speaker to be localized at a desired position to the front, back, left, or right.

In addition, the delay values and the coefficient values may be fixed or may be changed continuously in time. Furthermore, a delay value and a coefficient value are changed in conjunction with each other by the control unit 21, which allows the position of a virtual speaker to be well localized auditorily.

### Second Embodiment

<Example of Frontward or Backward Localization>

Next, frontward or backward localization conducted by the delay unit 22 in step S12 of FIG. 9 will be explained in detail with reference to FIGS. 10 to 14.

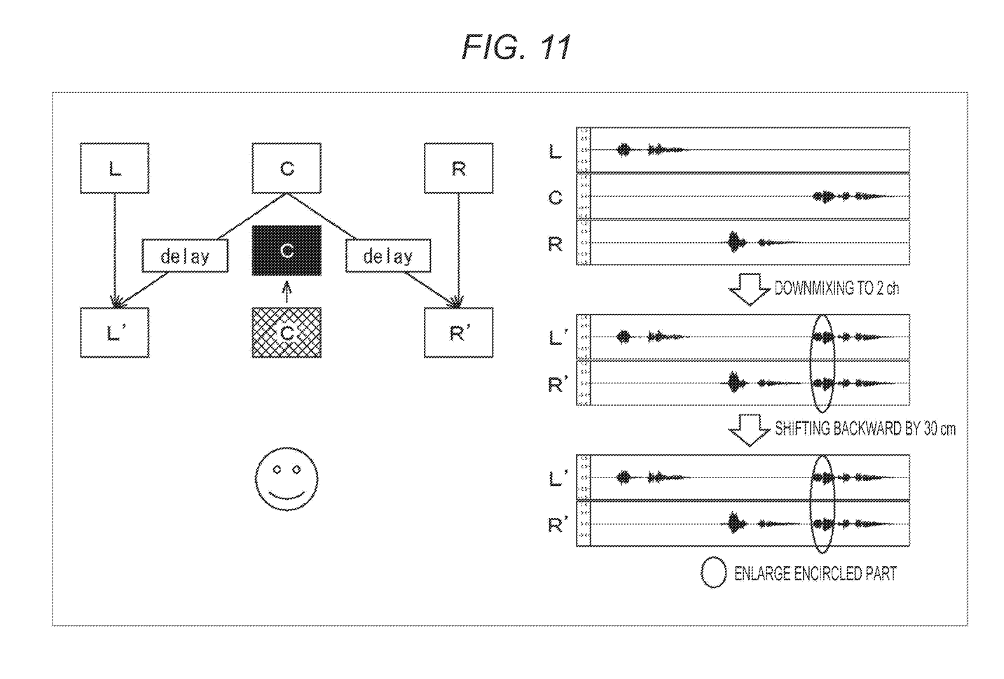

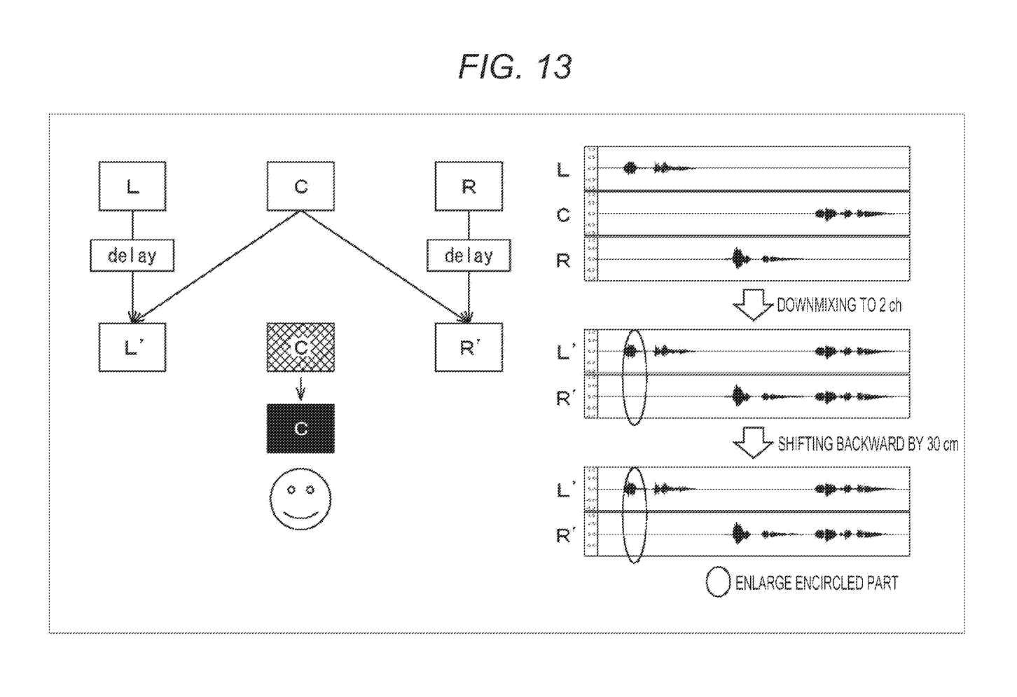

In an example of FIG. 10, L, C, and R on the top row represent audio signals of L, C, and R. L′ and R′ on the bottom row represent audio signals of L and R resulting from downmixing, and the positions thereof represent the positions of the speakers 12L and 12R, respectively. C on the bottom row represents the sound image position (virtual speaker position) of the channel C. Note that the same is applicable to examples of FIGS. 11 and 13.

Specifically, an example of downmixing three channels of L, C, and R to two channels of L′ and R′, or in other words, an example of localizing a sound image of the channel C frontward or backward by applying a delay to an audio signal of any of L, C, and R will be explained.

First, the example of FIG. 11 shows an example in which the sound image of the channel C is shifted backward by 30 cm from the position shown in FIG. 10. In this case, the delay unit 22 applies a delay value (delay) corresponding to the distance only to the audio signal of the channel C. Note that “delay” have the same value. As a result, the sound image of the channel C is localized at 30 cm to the back.

In addition, the right side of FIG. 11 illustrates waveforms of the input signals L, C, and R, waveforms of R′ and L′ resulting from downmixing to 2 channels, and waveforms of R′ and L′ resulting from further shifting the sound image of the channel C backward by 30 cm, in this order from the top.

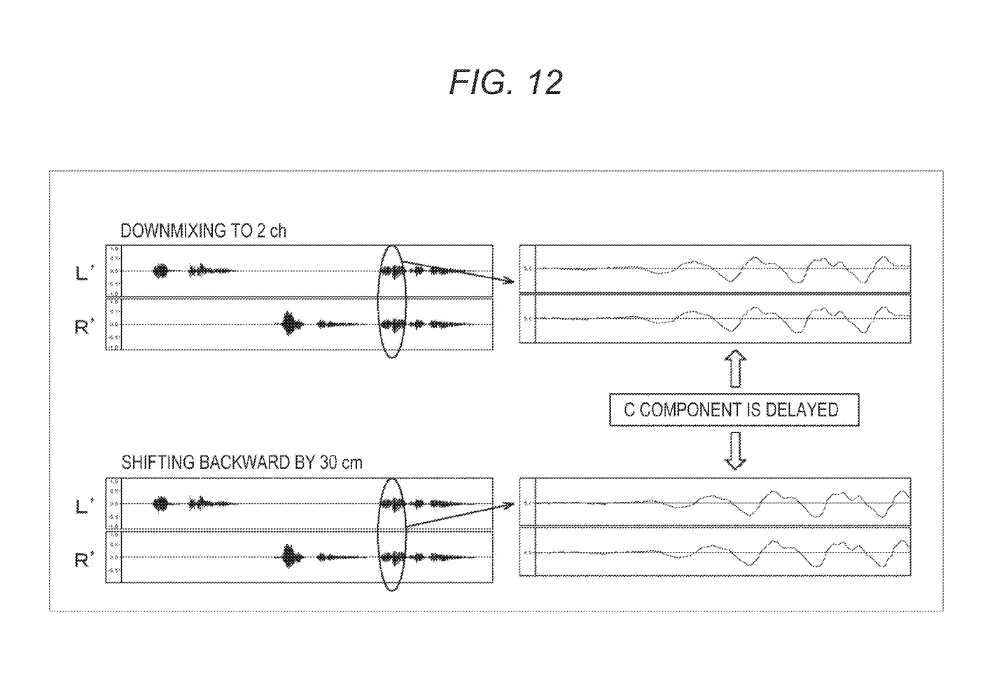

Note that enlarged waveforms of R′ and L′ resulting from downmixing to two channels alone and enlarged waveforms of R′ and L′ resulting from further shifting the sound image of the channel C backward by 30 cm (that is, applying a delay) are shown in FIG. 12.

In the example of FIG. 12, the upper graph represents audio signals obtained by combination without applying a delay, and the lower graph represents audio signals obtained by combination with a delay applied to the channel C. Comparison therebetween shows that the audio signals of the lower graph are temporally delayed from those of the upper graph (that is, the C component is delayed).

Next, the example of FIG. 13 shows an example in which the sound image of the channel C is shifted frontward by 30 cm from the position shown in FIG. 10. In this case, the delay unit 22 applies a delay value (delay) corresponding to the distances to the audio signals of the channel L and the channel R. Note that “delay” have the same value. As a result, the sound image of the channel C is localized at 30 cm to the front.

In addition, the right side of FIG. 13 illustrates waveforms of the input signals L, C, and R, waveforms of R′ and L′ resulting from downmixing to 2 channels, and waveforms of R′ and L′ resulting from further shifting the sound image of the channel C frontward by 30 cm, in this order from the top.

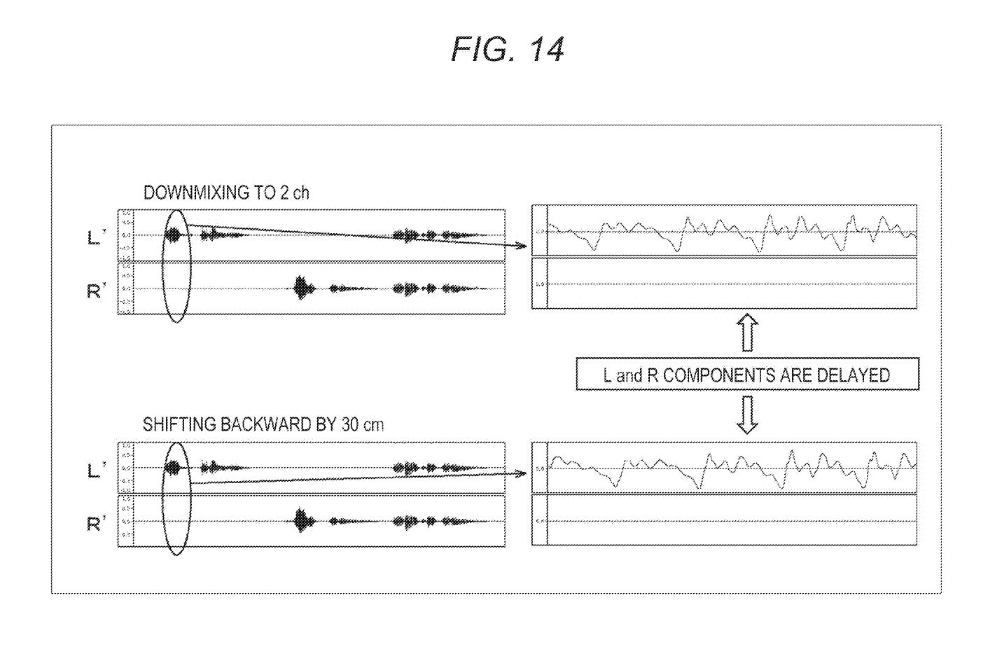

Note that enlarged waveforms of R′ and L′ resulting from downmixing to two channels alone and enlarged waveforms of R′ and L′ resulting from further shifting the sound image of the channel C frontward by 30 cm (that is, applying a delay to L and R) are shown in FIG. 14. The enlarged part, however, is where only the L′ component is present.

In the example of FIG. 14, the upper graph represents audio signals obtained by combination without applying a delay, and the lower graph represents audio signals obtained by combination with a delay applied to the channels L and R. Comparison therebetween shows that the audio signals of the lower graph are temporally delayed from those of the upper graph (that is, the R′ and L′ components are delayed).

As described above, the use of a delay in downmixing allows a sound image to be localized frontward or backward. In other words, the localization position of a sound image can be changed frontward or backward.

### Third Embodiment

<Example of Leftward or Rightward Localization>

Next, leftward or rightward localization conducted by the dividing unit 24 in step S14 of FIG. 9 will be explained in detail with reference to FIGS. 15 to 17.

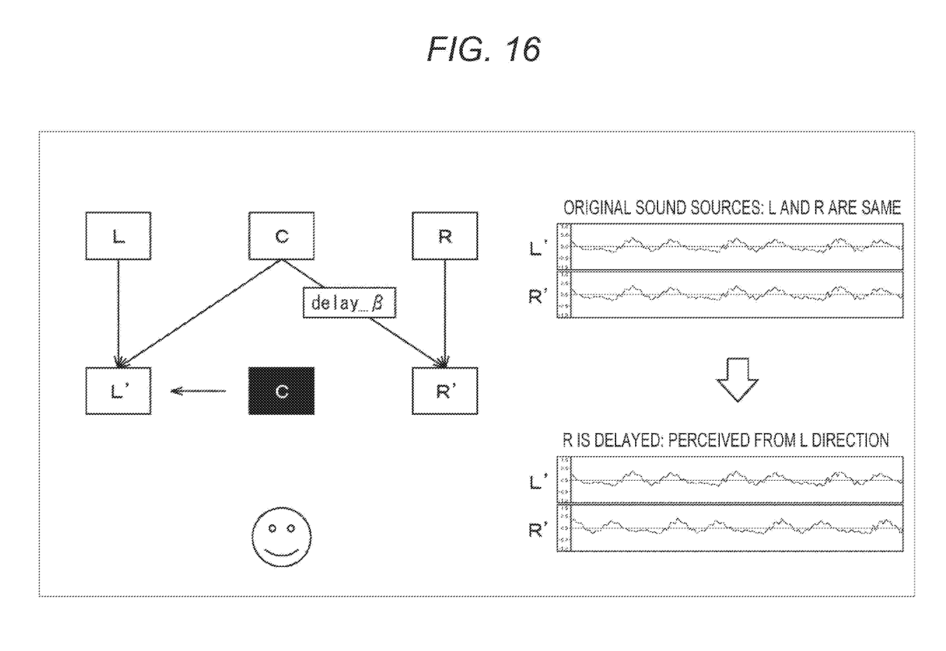

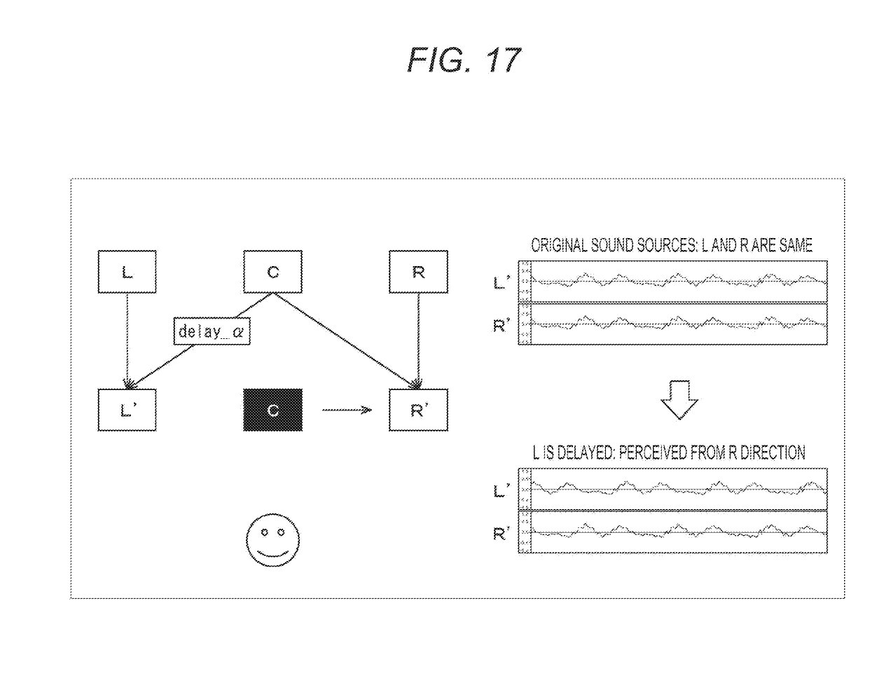

In an example of FIG. 15, L, C, and R on the top row represent audio signals of L, C, and R. L′ and R′ on the bottom row represent audio signals resulting from downmixing, and the positions thereof represent the positions of the speakers 12L and 12R, respectively. C on the bottom row represents the sound image position (virtual speaker position) of the channel C. Note that the same is applicable to examples of FIGS. 16 and 17.

Specifically, an example of downmixing three channels of L, C, and R to two channels of L′ and R′, or in other words, applying a delay value (delay) to an audio signal of any of L, C, and R. An example of localizing a sound image of the channel C to the left or right in this manner, which is the aforementioned Haas effect, will be described.

First, the example of FIG. 16 shows an example in which the sound image of the channel C is shifted toward L′ from the position shown in FIG. 10. In this case, the delay unit 22 applies delayβ corresponding to the distance only to the audio signal of the channel C to be combined with R′. As a result, the sound image of the channel C is localized toward L.

In addition, in the right side of FIG. 16, the upper graph represents waveforms of R′ and L′ resulting from downmixing to two channels alone, and the lower graph represents waveforms of R′ and L′ resulting from delaying only R′. Comparison therebetween shows that the audio signal of R′ is delayed from the audio signal of L′.

Next, the example of FIG. 17 shows an example in which the sound image of the channel C is shifted toward R′ from the position shown in FIG. 10. In this case, the delay unit 22 applies delayα corresponding to the distance only to the audio signal of the channel C to be combined with L′. As a result, the sound image of the channel C is localized toward R.

In addition, in the right side of FIG. 17, the upper graph represents waveforms of R′ and L′ resulting from downmixing to two channels alone, and the lower graph represents waveforms of R′ and L′ resulting from delaying only L′. Comparison therebetween shows that the audio signal of L′ is delayed from the audio signal of R′.

<Modification>

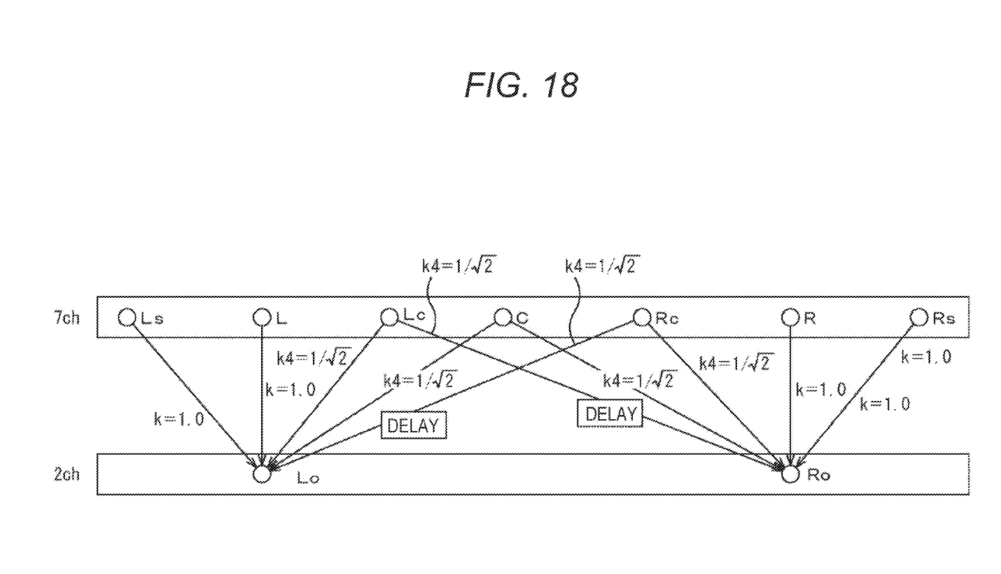

Another example of leftward or rightward localization will be explained with reference to FIG. 18. FIG. 18 is a diagram illustrating an example of downmixing seven channels of Ls, L, Lc, C, Rc, R, and Rs to two channels of Lo and Ro. The example of FIG. 18 is an example in which a coefficient for audio signals of Ls, L, R, and Rs is k=1.0, and a coefficient for audio signals of each of divided Lc, each of divided Rc, and C is k4=1/square root of 2.

In the example of FIG. 18, application of a certain delay to the channels Lc and Rc allows the sound images of Lc and Rc to be localized leftward or rightward. This is also leftward or rightward localization of sound images using the Haas effect.

Note that the leftward or rightward localization can also be conducted by changing the aforementioned coefficients (k in FIG. 18). In this case, however, power may not be constant. In contrast, the utilization of the Haas effect allows power to be kept constant and eliminates the need for changing the coefficients.

As described above, the use of a delay in downmixing and the utilization of the Haas effect allow a sound image to be localized leftward or rightward. In other words, the localization position of a sound image can be changed leftward or rightward.

### Fourth Embodiment

<Example Configuration of Device>

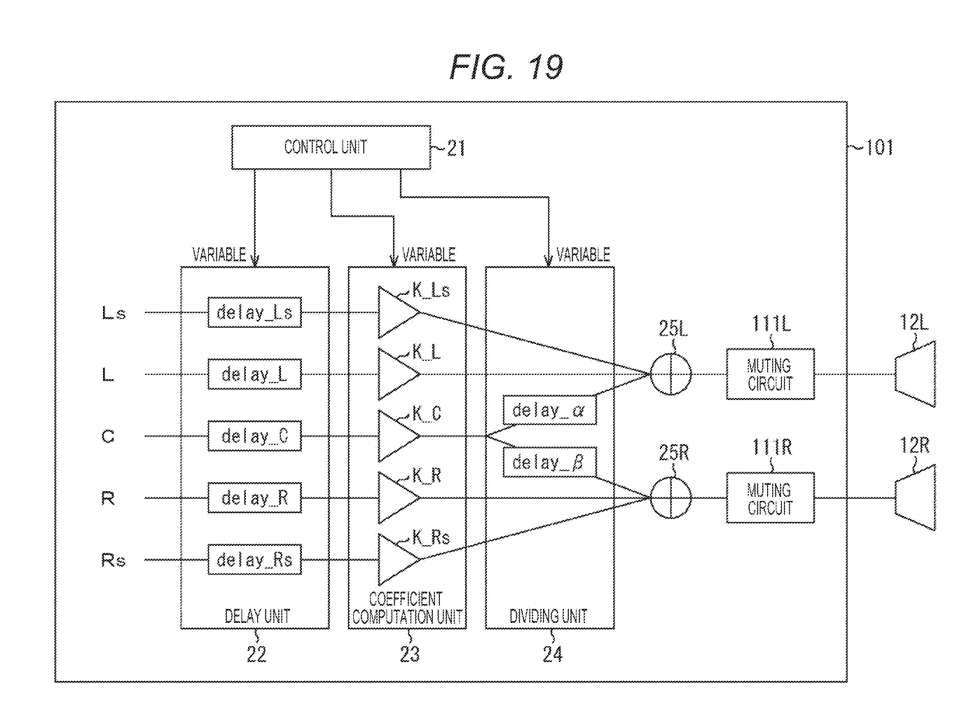

FIG. 19 is a block diagram illustrating another example configuration of a down mixer, which is an audio processing device to which the present technology is applied.

The downmixer 101 of FIG. 19 is the same as the downmixer 11 of FIG. 1 in including a control unit 21, a delay unit 22, a coefficient computation unit 23, a dividing unit 24, and combining units 25L and 25R.

The downmixer 101 of FIG. 19 is different from the downmixer 11 of FIG. 1 only in that the level control units 26L and 26R are replaced with muting circuits 111L and 111R.

Specifically, the muting circuit 111L mutes the audio signal from the combining unit 25L for correction of the audio signal, and outputs the muted audio signal to the speaker 12L. The muting circuit 111R mutes the audio signal from the combining unit 25R for correction of the audio signal, and outputs the muted audio signal to the speaker 12R.

This enables control in changing a delay value and a coefficient value during reproduction so as not to output noise which may be contained in an output signal, for example.

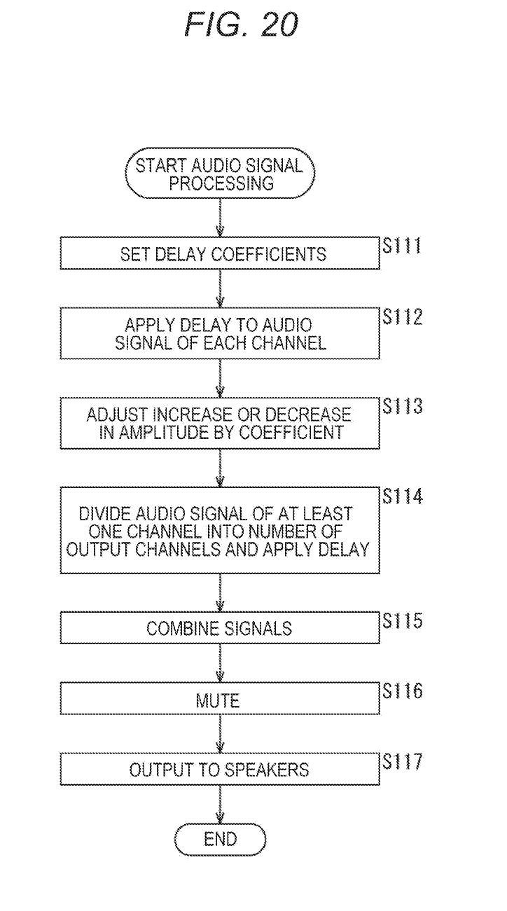

Next, downmixing performed by the downmixer 101 of FIG. 19 will be explained with reference to a flowchart of FIG. 20. Note that, since steps S111 to S115 in FIG. 20 are processes that are basically similar to steps S11 to S15 in FIG. 9, the description thereof will not be repeated.

In step S116, the muting circuit 111L and the muting circuit 111R mute the audio signals from the combining unit 25L and the combining unit 25R, respectively, and output the muted audio signals to the speaker 12L and the speaker 12R, respectively.

In step S117, the speaker 12L and the speaker 12R outputs audio corresponding to the audio signals from the muting circuit 111L and the muting circuit 111R, respectively.

This can prevent or reduce output of noise, which may be contained as a result of changing a delay value and a coefficient value.

Note that, although examples in which either of the level control units and the muting circuits are provided as units for correcting audio signals in the downmixer have been explained in the description above, both of the level control units and the muting circuit may be provided. In this case, the level control units and the muting circuits may be arranged in any order.

In addition, the number of input channels may be any number of two or larger, and is not limited to five channels or seven channels as mentioned above. Furthermore, the number of output channels may also be any number of two or larger, and is not limited to two channels as mentioned above.

The series of processes described above can be performed either by hardware or by software. When the series of processes described above is performed by software, programs constituting the software are installed in a computer. Note that examples of the computer include a computer embedded in dedicated hardware and a general-purpose personal computer capable of executing various functions by installing various programs therein.

### Fifth Embodiment

<Example Configuration of Computer>

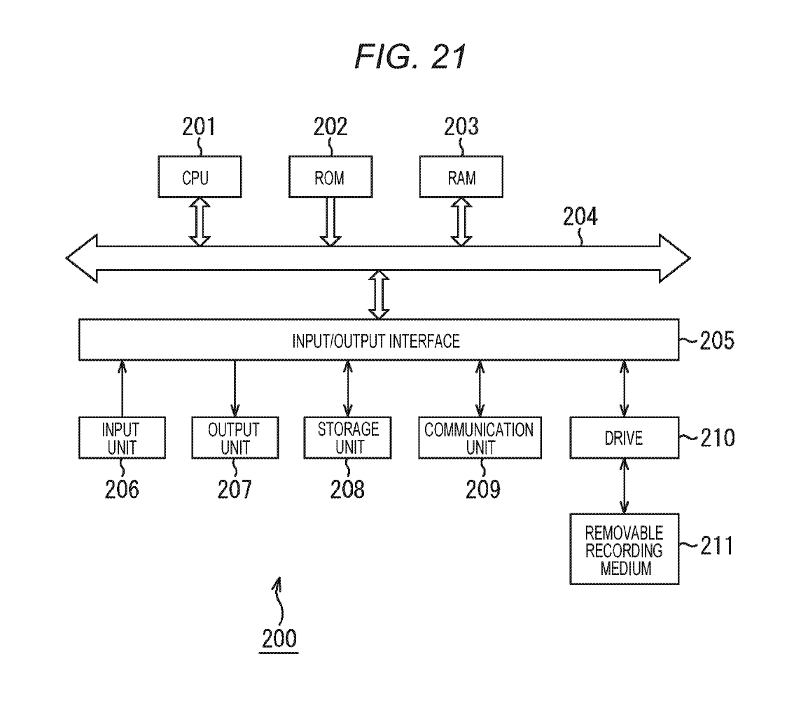

FIG. 21 is a block diagram illustrating an example hardware configuration of a computer that performs the above-described series of processes in accordance with programs.

In a computer 200, a central processing unit (CPU) 201, a read only memory (ROM) 202, and a random access memory (RAM) 203 are connected to one another by a bus 204.

An input/output interface 205 is further connected to the bus 204. An input unit 206, an output unit 207, a storage unit 208, a communication unit 209, and a drive 210 are connected to the input/output interface 205.

The input unit 206 includes a keyboard, a mouse, a microphone, and the like. The output unit 207 includes a display, a speaker, and the like. The storage unit 208 may be a hard disk, a nonvolatile memory, or the like. The communication unit 209 may be a network interface or the like. The drive 210 drives a removable recording medium 211 such as a magnetic disk, an optical disk, a magnetooptical disk, or a semiconductor memory.

In the computer having the above described configuration, the CPU 201 loads a program stored in the storage unit 208 into the RAM 203 via the input/output interface 205 and the bus 204 and executes the program, for example, so that the above described series of processes are performed.

Programs to be executed by the computer (CPU 201) may be recorded on a removable recording medium 211 that is a package medium or the like and provided therefrom, for example. Alternatively, the programs can be provided via a wired or wireless transmission medium such as a local area network, the Internet, or digital broadcasting.

In the computer, the programs can be installed in the storage unit 208 via the input/output interface 205 by mounting the removable recording medium 211 on the drive 210. Alternatively, the programs can be received by the communication unit 209 via a wired or wireless transmission medium and installed in the storage unit 208. Still alternatively, the programs can be installed in advance in the ROM 202 or the storage unit 208.

Note that programs to be executed by the computer may be programs for carrying out processes in chronological order in accordance with the sequence described in this specification, or programs for carrying out processes in parallel or at necessary timing such as in response to a call.

In addition, the term system used herein refers to general equipment constituted by a plurality of devices, blocks, means, and the like.

Note that embodiments of the present disclosure are not limited to the embodiments described above, but various modifications may be made thereto without departing from the scope of the disclosure.

While preferred embodiments of the present disclosure have been described above with reference to the accompanying drawings, the disclosure is not limited to these examples. It is apparent that a person ordinary skilled in the art to which the present disclosure belongs can conceive of various variations and modifications within the technical idea described in the claims, and it is naturally appreciated that these variations and modification belongs within the technical scope of the present disclosure.

Note that the present technology can also have the following configurations.

(1) An audio processing device including:

a delay unit configured to apply a delay to input audio signals of two or more channels depending on each of the channels;

a setting unit configured to set a value of the delay; and

a combining unit configured to combine the audio signals delayed by the delay unit, and output audio signals of output channels.

(2) An audio processing method wherein an audio processing device:

applies a delay to input audio signals of two or more channels depending on each of the channels;

sets a value of the delay; and

combines the delayed audio signals, and outputs audio signals of output channels.

(3) An audio processing device including:

a delay unit configured to apply a delay to input audio signals of two or more channels depending on each of the channels;

an adjustment unit configured to adjust an increase or decrease in amplitude of the audio signals delayed by the delay unit;

a setting unit configured to set a value of the delay and a coefficient value indicating the increase or decrease; and

a combining unit configured to combine the audio signals subjected to adjustment of the increase or decrease in amplitude by the adjustment unit, and output audio signals of output channels.

(4) The audio processing device described in (3), wherein the setting unit sets the value of the delay and the coefficient value in conjunction with each other.

(5) The audio processing device described in (3) or (4), wherein for localizing a sound image frontward relative to a listening position, the setting unit sets the coefficient value so that sound becomes louder, and for localizing a sound image backward, the setting unit sets the coefficient value so that sound becomes less loud.

(6) The audio processing device described in any one of (3) to (5), further including a correction unit configured to correct the audio signals subjected to adjustment of the increase or decrease in amplitude by the adjustment unit.

(7) The audio processing device described in (6), wherein the correction unit controls a level of the audio signals subjected to adjustment of the increase or decrease in amplitude by the adjustment unit.

(8) The audio processing device described in (6), wherein the correction unit mutes the audio signals subjected to adjustment of the increase or decrease in amplitude by the adjustment unit.

(9) An audio processing method wherein an audio processing device:

applies a delay to input audio signals of two or more channels depending on each of the channels;

adjusts an increase or decrease in amplitude of the delayed audio signals;

sets a value of the delay and a coefficient value indicating the increase or decrease; and

combines the audio signals subjected to adjustment of the increase or decrease in amplitude, and outputs audio signals of output channels.

(10) An audio processing device including:

a dividing unit configured to apply a delay to at least an audio signal of one channel among input audio signals of two or more channels, and divide the delayed audio signal into two or more output channels;

a combining unit configured to combine an input audio signal with the audio signal obtained by the division by the dividing unit, and output an audio signal of the output channels; and

a setting unit configured to set a value of the delay depending on each of the output channels.

(11) The audio processing device described in (10), wherein the setting unit sets the value of the delay so as to produce a Haas effect.

(12) An audio processing method wherein an audio processing device:

applies a delay to at least an audio signal of one channel among input audio signals of two or more channels, and divide the delayed audio signal into two or more output channels;

combines an input audio signal with the audio signal obtained by the division by the dividing unit, and outputs an audio signal of the output channels; and

sets a value of the delay depending on each of the output channels.

### REFERENCE SIGNS LIST

11 Downmixer
12L, 12R Speaker
21 Control unit
22 Delay unit
23 Coefficient computation unit
24 Dividing unit
25L, 25R Combining unit
26L, 26R Level control unit
101 Downmixer
111L, 111R Muting circuit

1. An audio processing device comprising:
a delay unit configured to apply a delay to input audio signals of two or more channels depending on each of the channels;
a setting unit configured to set a value of the delay; and
a combining unit configured to combine the audio signals delayed by the delay unit, and output audio signals of output channels.

2. An audio processing method wherein an audio processing device:
applies a delay to input audio signals of two or more channels depending on each of the channels;
sets a value of the delay; and
combines the delayed audio signals, and outputs audio signals of output channels.

3. An audio processing device comprising:
a delay unit configured to apply a delay to input audio signals of two or more channels depending on each of the channels;
an adjustment unit configured to adjust an increase or decrease in amplitude of the audio signals delayed by the delay unit;
a setting unit configured to set a value of the delay and a coefficient value indicating the increase or decrease; and
a combining unit configured to combine the audio signals subjected to adjustment of the increase or decrease in amplitude by the adjustment unit, and output audio signals of output channels.

4. The audio processing device according to claim 3, wherein the setting unit sets the value of the delay and the coefficient value in conjunction with each other.

5. The audio processing device according to claim 4, wherein for localizing a sound image frontward relative to a listening position, the setting unit sets the coefficient value so that sound becomes louder, and for localizing a sound image backward, the setting unit sets the coefficient value so that sound becomes less loud.

6. The audio processing device according to claim 3, further comprising a correction unit configured to correct the audio signals subjected to adjustment of the increase or decrease in amplitude by the adjustment unit.

7. The audio processing device according to claim 6, wherein the correction unit controls a level of the audio signals subjected to adjustment of the increase or decrease in amplitude by the adjustment unit.

8. The audio processing device according to claim 6, wherein the correction unit mutes the audio signals subjected to adjustment of the increase or decrease in amplitude by the adjustment unit.

9. An audio processing method wherein an audio processing device:
applies a delay to input audio signals of two or more channels depending on each of the channels;
adjusts an increase or decrease in amplitude of the delayed audio signals;
sets a value of the delay and a coefficient value indicating the increase or decrease; and
combines the audio signals subjected to adjustment of the increase or decrease in amplitude, and outputs audio signals of output channels.

10. An audio processing device comprising:
a dividing unit configured to apply a delay to at least an audio signal of one channel among input audio signals of two or more channels, and divide the delayed audio signal into two or more output channels;
a combining unit configured to combine an input audio signal with the audio signal obtained by the division by the dividing unit, and output an audio signal of the output channels; and
a setting unit configured to set a value of the delay depending on each of the output channels.

11. The audio processing device according to claim 10, wherein the setting unit sets the value of the delay so as to produce a Haas effect.

12. An audio processing method wherein an audio processing device:
applies a delay to at least an audio signal of one channel among input audio signals of two or more channels, and divide the delayed audio signal into two or more output channels;
combines an input audio signal with the audio signal obtained by a division by a dividing unit, and outputs an audio signal of the output channels; and
sets a value of the delay depending on each of the output channels.
